(19) United States
(12) Patent Application Publication
(10) Pub. No.: US 2006/0222066 A1
(43) Pub. Date: Oct. 5, 2006

(54) Intra prediction method and apparatus

(75) Inventors: Ki-won Yoo, Seoul (KR); Jong-gu Jeon, Suwon-si (KR); Young-sup Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/240,616

(22) Filed: Oct. 3, 2005

(30) Foreign Application Priority Data
Apr. 4, 2005 (KR) 10-2005-0028078

(51) Int. Cl. H04N 11/04; H04N 11/02; H04B 1/66; H04N 7/12

(52) U.S. Cl. 375/240.03; 375/240.24; 375/240.18

(57) ABSTRACT

An intra prediction method and apparatus. The intra prediction method of intra predicting a macroblock divided into a plurality of blocks includes intra predicting the plurality of blocks in a predetermined scanning order. One or more block among the plurality of blocks are intra predicted independently of their respective, immediate preceding block that is intra predicted immediately before the one or more blocks are intra predicted and are intra predicted in parallel with their respective, immediate preceding blocks.

### CROSS-REFERENCE TO RELATED PATENT APPLICATION

This application claims priority from Korean Patent Application No. 10-2005-0028078, filed on Apr. 4, 2005, in the Korean Intellectual Property Office, the disclosure of which is incorporated herein in its entirety by reference.

### BACKGROUND OF THE INVENTION

1. Field of the Invention

The present invention relates to encoding and decoding of video data. More particularly, the present invention relates to an intra prediction method and apparatus, in which the time required for intra prediction can be reduced.

2. Description of the Related Art

According to the video compression standard H.264/AVC, a picture is divided into macroblocks for video encoding. Among encoding modes that are available in inter prediction and intra prediction, one encoding mode is selected according to a bit rate required for encoding of macroblocks and the degree of distortion between the original macroblocks and decoded macroblocks and the encoding is performed in the selected encoding mode.

In intra prediction, the encoding is performed through a spatial prediction using adjacent pixels that have been already encoded. Intra prediction is roughly divided into an intra 4×4 mode, an intra 8×8 mode (in the case of a high profile), and an intra 16×16 mode.

FIG. 1 illustrates macroblocks, each of which is divided into blocks, and scanning orders in intra modes according to prior art.

Referring to FIG. 1, blocks included in a macroblock are intra predicted in a predetermined order. Referring to FIG. 1A, in an intra 4×4 mode, intra prediction is performed in the order of a 0^{th} 4×4 block, then a 1^{st} 4×4 block, then a 2^{nd} 4×4 block, then a 3^{rd} 4×4 block and is terminated after intra prediction of a 15^{th} 4×4 block is completed. Referring to FIG. 1B, in an intra 8×8 mode, intra prediction is performed in the order of an 0^{th} 8×8 block, then a 1^{st} 8×8 block, then a 2^{nd} 8×8 block, then a 3^{rd} 8×8 block. Referring to FIG. 1C, in an intra 16×16 mode, intra prediction is performed one time on a macroblock.

FIG. 2 illustrates intra 4×4 modes according to the prior art.

Referring to FIG. 2, the intra 4×4 modes include a total of 9 modes, i.e., a direct current (DC) mode, a vertical mode, a horizontal mode, a diagonal down-left mode, a diagonal down-right mode, a vertical left mode, a vertical right mode, a horizontal up mode, and a horizontal down mode.

FIG. 3 is a view for explaining adjacent pixels used in an intra 4×4 mode according to the prior art.

Referring to FIG. 3, lowercase letters a through p represent pixels corresponding to a current 4×4 block to be intra predicted and capital letters A through M represent adjacent samples or pixels required for intra prediction of the current 4×4 block, which have been previously encoded and reconstructed. As shown in FIG. 3, to perform an intra prediction mode process, the adjacent pixels A through M that are required for intra prediction of the current block should be processed first.

FIG. 4 is a view a process in an intra 4×4 according to the prior art. Here, P# denotes intra prediction process of a #^{th} block and T# denotes transformation, quantization, and inverse transformation process of the #^{th} block.

Referring to FIG. 4, intra prediction of a current block is possible only after the immediate preceding block of the current block undergoes intra prediction, transformation, quantization, and inverse transformation process and pixel information of the immediately previous block is obtained. According to the scanning order as shown in (a) of FIG. 1, pixel information of adjacent blocks that are located on the left side and above of a current block is required for intra prediction of the current block. Thus, intra prediction process of the current block can be initiated only after the processing of its immediate preceding block is completed. In FIG. 4, given that the time required for each process of P# and T# is one clock cycle, intra prediction process of a macroblock requires a total of 32 clock cycles.

Thus, according to the scanning order of blocks in a conventional intra prediction, i.e., the processing order of blocks in the conventional intra prediction, the intra prediction of a current block can be initiated only after the processing of its immediate preceding block is completed. Since, in the prior art, the processing of the immediate preceding block and the intra prediction of a current block are sequentially performed, a large amount of time is required for the intra prediction.

### SUMMARY OF THE INVENTION

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

One aspect of the present invention is to provide an intra prediction method and apparatus, in which the time required for intra prediction is reduced in an encoding or decoding of video data.

Another aspect of the present invention is to provide an intra prediction method and apparatus, in which intra prediction is simplified by improving the scanning order of blocks in an intra prediction mode in encoding or decoding of video data.

According to an aspect of the present invention, an intra prediction method of intra predicting a macroblock divided into a plurality of blocks is provided. The intra prediction method includes intra predicting the plurality of blocks in a predetermined scanning order. One or more blocks among the plurality of blocks is intra predicted independently of its immediate preceding block that is intra predicted immediately before the respective block from one or more blocks. These one or more blocks are intra predicted in parallel with their respective, immediate preceding blocks.

According to another aspect of the present invention, there is provided an intra prediction method of intra predicting a macroblock in units of a predetermined block. The intra prediction method includes requesting pixel information of adjacent blocks required for intra prediction of the predetermined block in a predetermined scanning order and receiving the requested pixel information of adjacent blocks and performing the intra prediction. The predetermined scanning order enables one or more blocks to be intra predicted in parallel with their respective, immediate preceding blocks.

According to yet another aspect of the present invention, there is provided an intra prediction apparatus for intra predicting a macroblock divided into a plurality of blocks. The intra prediction apparatus includes an adjacent pixel information providing unit and a prediction unit. The adjacent pixel information providing unit provides pixel information of adjacent blocks used in the intra prediction. The prediction unit requests the pixel information of adjacent blocks from the adjacent pixel information providing unit and performs intra prediction using the received pixel information of adjacent blocks. The prediction unit performs the intra prediction in a predetermined scanning order that enables one or more blocks to be intra predicted in parallel with their respective, immediate preceding block.

### BRIEF DESCRIPTION OF THE DRAWINGS

The above and/or other aspects of the present invention will become more apparent by describing in detail exemplary embodiments thereof with reference to the accompanying drawings. In the drawings, the same reference characters denote analogous elements, in which:

FIG. 1 illustrates macroblocks, each of which is divided into blocks, and scanning orders in intra modes according to the prior art;

FIG. 2 illustrates intra 4×4 modes, according to the prior art;

FIG. 3 is a view for explaining adjacent pixels used in an intra 4×4 mode according to the prior art;

FIG. 4 is a view for explaining a process in an intra 4×4 mode according to the prior art;

FIG. 5 is a view of the scanning order of 4×4 blocks included in a macroblock when intra prediction is performed according to an exemplary, non-limiting embodiment of the present invention;

FIG. 6 illustrates pixel information of adjacent blocks required for the intra prediction of a 4×4 block in the scanning order according to an exemplary, non-limiting embodiment of the present invention;

FIG. 7 is a view of a process in an intra prediction of a 4×4 block in the scanning order according to an exemplary embodiment of the present invention;

FIG. 8 is a view of a process in an intra prediction of a 8×8 block in the scanning order according to an exemplary embodiment of the present invention;

FIG. 9 is a block diagram of an encoder according to an exemplary embodiment of the present invention;

FIG. 10 is a block diagram of a decoder according to an exemplary embodiment of the present invention;

FIG. 11 is a block diagram of an intra prediction unit used in an encoder and a decoder according to an exemplary embodiment of the present invention; and

FIG. 12 is a flowchart illustrating an intra prediction method according to an exemplary embodiment of the present invention.

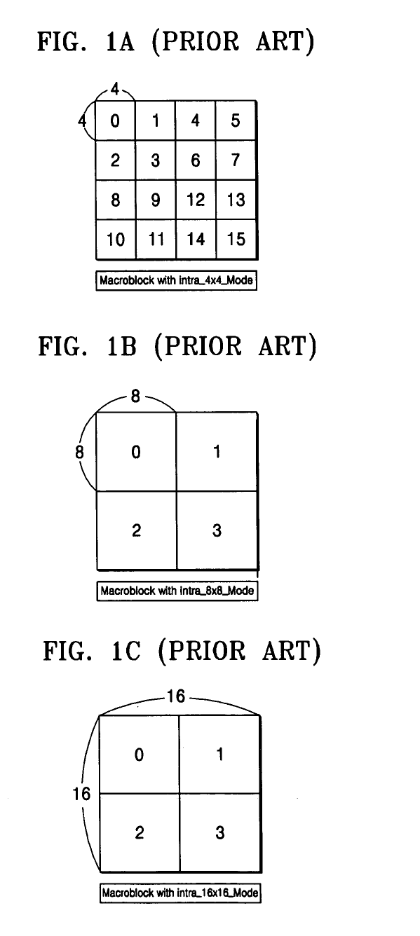

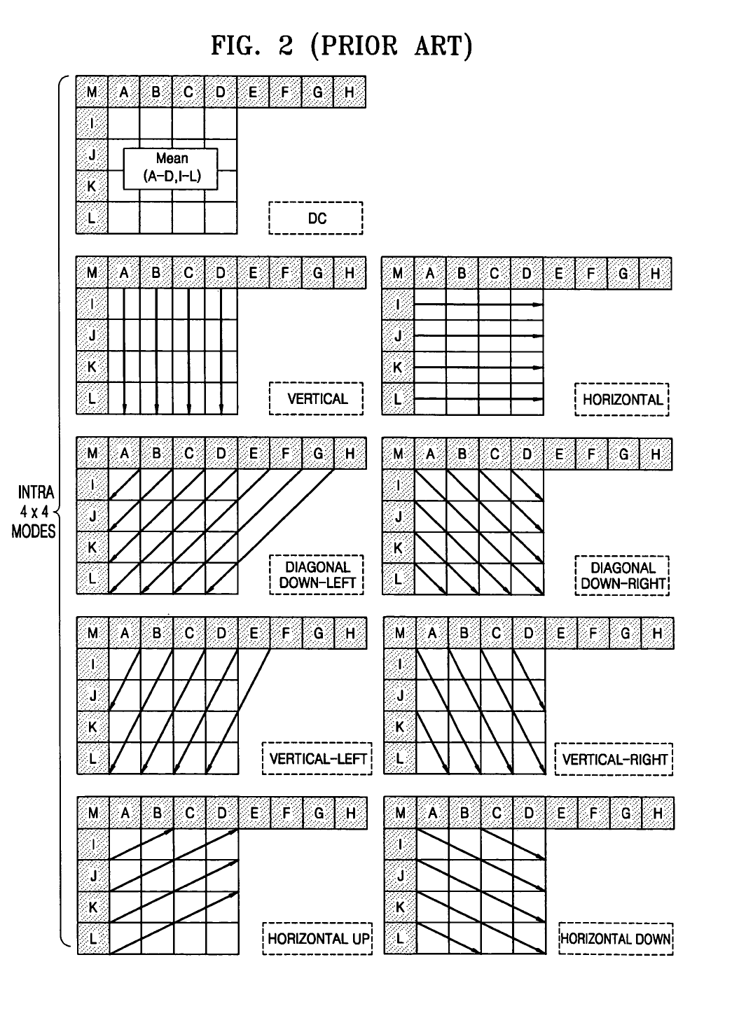

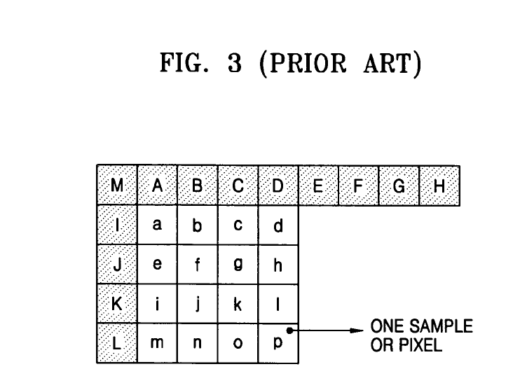

### DETAILED DESCRIPTION OF THE EXEMPLARY EMBODIMENTS

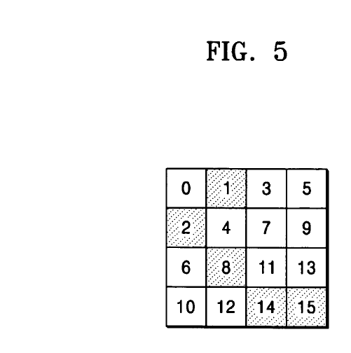

FIG. 5 is a perspective view of the scanning order of 4×4 blocks included in a macroblock when intra prediction is performed, according to exemplary embodiments of the present invention.

Referring to FIG. 5, in the exemplary embodiment of the present invention, parallel intra prediction using a pipeline technique can be performed on some blocks in a scanning order that is different from a conventionally defined scanning order, thereby reducing the time required for intra prediction. In other words, when intra prediction is performed in a processing order, as shown in FIG. 5, intra prediction of blocks, except for 1^{st}, 2^{nd}, 8^{th}, 14^{th}, and 15^{th} blocks (depicted as dashed blocks), can be initiated before pixel information of their immediate preceding blocks are obtained through transformation, quantization, and inverse transformation (which will be referred to as a “TnQ” processing for the sake of linguistic convenience only). Accordingly, the time required for intra prediction is reduced.

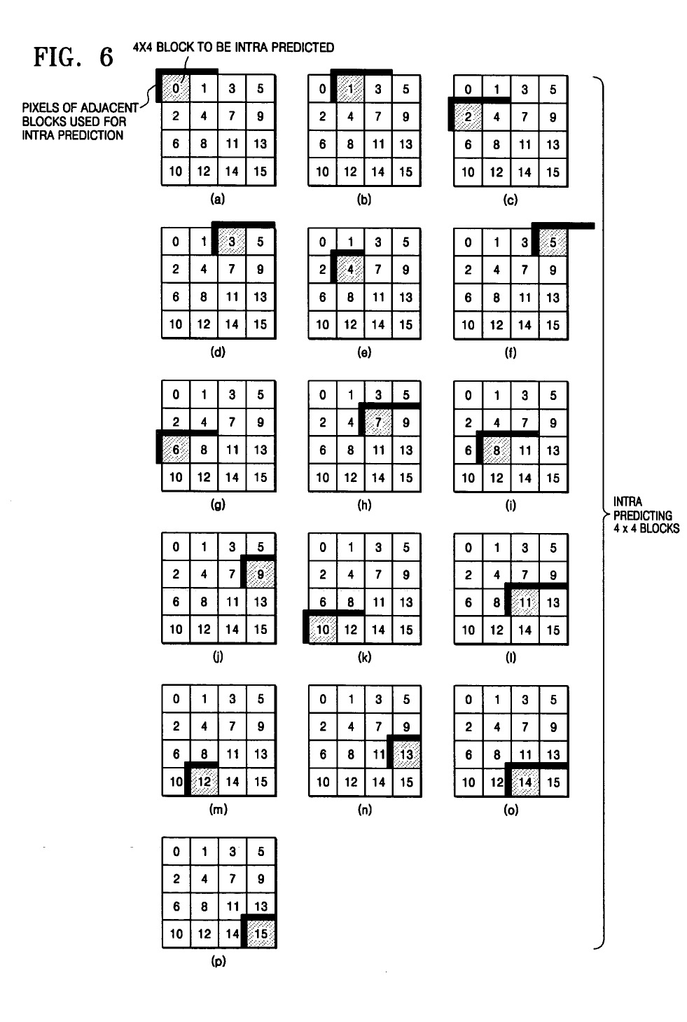

Intra prediction of each of 4×4 blocks in a scanning order according to the exemplary embodiment of the present invention will be described with reference to FIG. 6. FIG. 6 shows pixel information of adjacent blocks required for intra prediction. Dashed blocks in (a) through (q) of FIG. 6 represent current blocks that will be intra predicted, and areas marked with bold lines around the current blocks represent pixels of adjacent blocks used for intra prediction of the current blocks.

Referring to (a) of FIG. 6, a 0^{th} block is first intra predicted using pixel information of adjacent blocks included in its immediate preceding macroblock.

Referring to (b) of FIG. 6, a 1^{st} block is intra predicted using partial pixel information of its immediate preceding block, i.e., the 0^{th} block. Thus, after intra prediction and TnQ processing of the 0^{th} block are completed, intra prediction of the 1^{st} block can be initiated.

Similarly, referring to (c) of FIG. 6, since pixel information of previous blocks, i.e., the 0^{th} and 1^{st} blocks in a current macroblock are used for intra prediction of a 2^{nd} block, intra prediction of the 2^{nd} block can be initiated only after intra prediction and the TnQ processing of the 0^{th} and 1^{st} blocks are completed.

Referring to (d) through (h) of FIG. 6, pixel information of adjacent blocks are used for intra prediction of a current block, but pixel information of the immediate preceding block of the current block is not used. In other words, if a current block to be intra predicted is an n^{th} block, pixel information of an (n−1)^{th} block is not used for intra prediction of the n^{th} block. Thus, in this case, intra prediction of the n^{th} block can be initiated in parallel immediately after the intra prediction of the (n−1)^{th} block is initiated.

Referring to (i) of FIG. 6, since pixel information of a 7^{th} block is used for the intra prediction of an 8^{th} block, the intra prediction of the 8^{th} block can be initiated after the intra prediction and the TnQ processing of the 7^{th} block are completed.

Referring to (j) through (n) of FIG. 6, like in (d) through (h), pixel information of an immediate preceding block is not used for intra prediction of each of 9^{th} through 13^{th} blocks. Thus, the intra prediction of each of the 9^{th} through 13^{th} blocks can be initiated in parallel after the intra prediction of its immediate preceding block is initiated.

Referring to (o) of FIG. 6, since pixel information of the 13^{th} block is used for intra prediction of a 14^{th} block, intra prediction of the 14^{th} block can be initiated after the intra prediction and the TnQ processing of the 13^{th} block are completed.

Referring to (p) of FIG. 6, since pixel information of the 14^{th} block is used for intra prediction of a 15^{th} block, intra prediction of the 15^{th} block can be initiated after the intra prediction and the TnQ processing of the 14^{th} block are completed.

According to the scanning order of blocks in the exemplary embodiment of the present invention, intra prediction of the other blocks except for blocks that can be intra predicted only after processing of their immediate preceding blocks is completed, i.e., except for the 1^{st}, 2^{nd}, 8^{th}, 14^{th}, and 15^{th} blocks, can be initiated in parallel before the processing of their immediate preceding blocks is completed. In other words, the other blocks are intra predicted using pixel information of blocks that have been intra predicted at least two blocks earlier than the other blocks. That is, these blocks are intra predicted independently of the intra prediction of their respective immediate preceding blocks. Thus, the intra prediction of the other blocks can be performed in parallel with the intra prediction of their immediate preceding blocks.

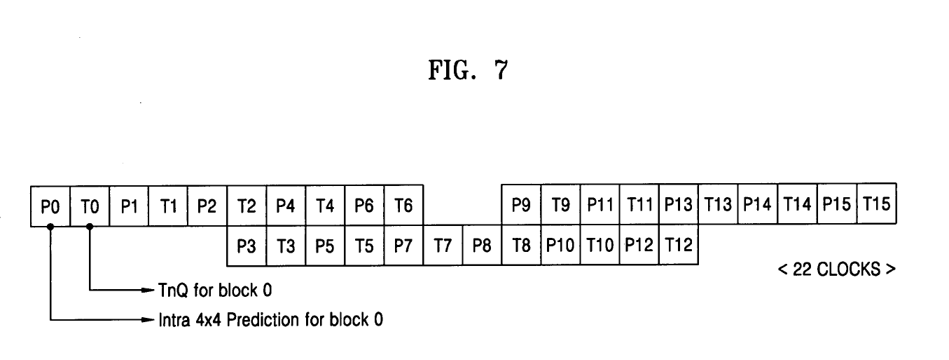

FIG. 7 is a perspective view of a process in an intra processing of 4×4 blocks in the scanning order according to the exemplary embodiment of the present invention, where P# represents an intra prediction process of a #^{th} block and T# represents a TnQ processing of the #^{th} block.

Referring to FIG. 7, as described above, the intra prediction of the 1^{st}, 2^{nd}, 8^{th}, 14^{th}, and 15^{th} blocks can be initiated after the intra prediction and the TnQ processing of their immediate preceding blocks, i.e., the 0^{th}, 1^{st}, 7^{th}, 13^{th}, and 14^{th} blocks, are completed. In other words, P1 can be initiated after completion of P0 and T0, P2 can be initiated after completion of P1 and T1, P8 can be initiated after completion of P7 and T7, P14 can be initiated after completion of P13 and T13, and P15 can be initiated after completion of P14 and T14. Intra prediction of the other blocks can be initiated in parallel before processing of their immediate preceding blocks is completed.

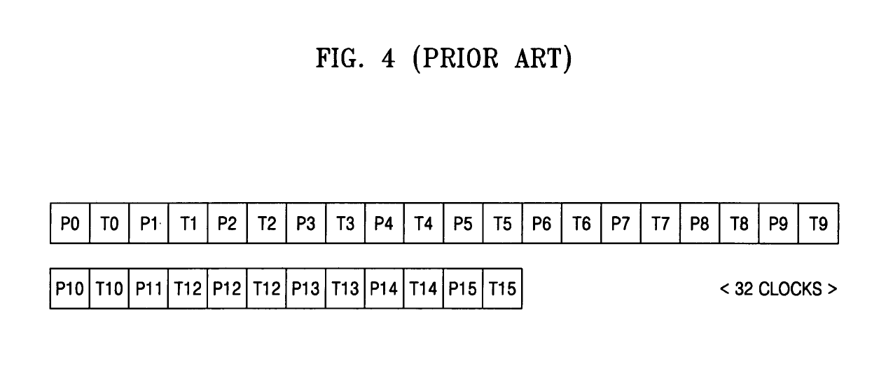

Assuming that the time required for each of P# and T# is one clock cycle, a total of 22 clock cycles are required for intra prediction of a macroblock in the scanning order according to the exemplary embodiment of the present invention. Thus, the time required for intra prediction according to the exemplary embodiment of the present invention is reduced by 40% when compared to a total of 32 clock cycles according to a conventional scanning order described with reference to FIG. 4.

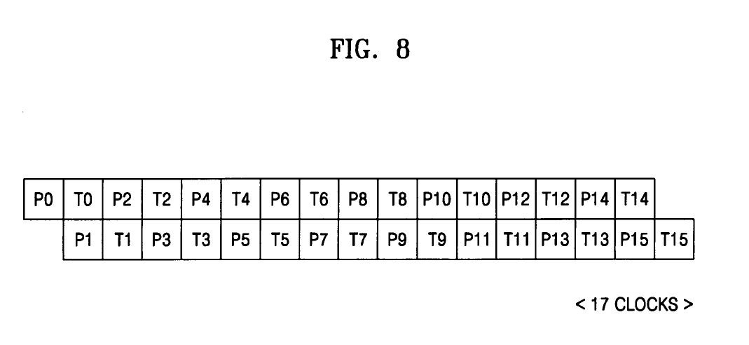

FIG. 8 is a perspective view of a process in an intra 8×8 mode in the scanning order according to the exemplary embodiment of the present invention, where the intra prediction of an 8×8 block is performed using a codec device for intra predicting a 4×4 block. This is because if a separate intra prediction apparatus for processing blocks having various sizes is included in the codec device, its manufacturing cost increases and it is difficult to implement.

Referring to FIG. 8, assuming that the time required for each of P# and T# is one clock cycle, it can be seen that intra prediction of an 8×8 block in the scanning order, according to the exemplary embodiment of the present invention, requires a total of 17 clock cycles. In FIGS. 7 and 8, the actual clock cycles may vary according to the actual time required for the intra prediction and the TnQ process of a 4×4 block. Examples shown in FIGS. 7 and 8 are only designed to show that the time required for the intra prediction can be reduced in the scanning order according to the exemplary embodiment of the present invention. The scanning order according to the exemplary embodiment of the present invention can be applied to an inter prediction and an intra prediction of 16×16 blocks and reduce the time required for the predictions.

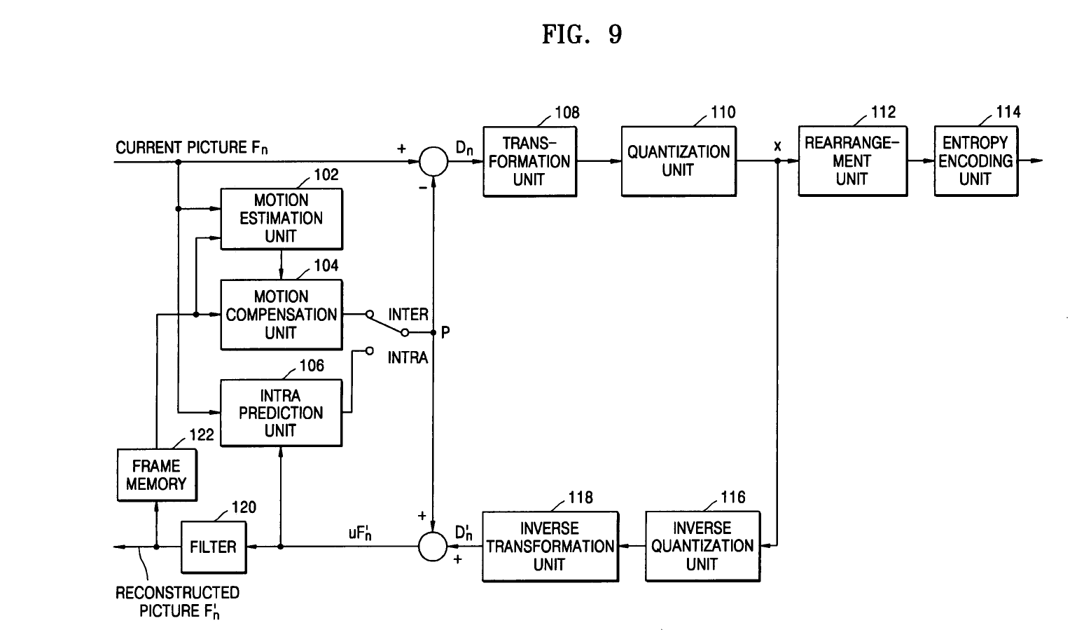

FIG. 9 is a block diagram of an encoder according to the exemplary embodiment of the present invention.

The encoder depicted in FIG. 9 includes a motion estimation unit 102, a motion compensation unit 104, an intra prediction unit 106, a transformation unit 108, a quantization unit 110, a rearrangement unit 112, an entropy-encoding unit 114, an inverse-quantization unit 116, an inverse-transformation unit 118, a filter 120, and a frame memory 122.

The encoder encodes a macroblock of a current picture in a mode selected from among various encoding modes. To this end, rate-distortion (RD) costs are calculated by performing encoding in all the possible modes of inter prediction and intra prediction, and by selecting a mode having the smallest RD cost as the optimal encoding mode. Then, the encoding is performed in the selected optimal encoding mode.

For inter prediction, the motion estimation unit 102 searches in a reference picture for a prediction value of a macroblock of a current picture. If the motion estimation unit 102 searches for a reference block in units of a ½ pixel or a ¼ pixel, the motion compensation unit 104 calculates an intermediate pixel and determines data of the reference block. As such, the inter prediction is performed by the motion estimation unit 102 and the motion compensation unit 104.

The intra prediction unit 106 performs intra prediction where a prediction value of a macroblock of a current picture is searched for in the current picture. To determine whether to perform the inter prediction or the intra prediction on a current macroblock, RD costs are calculated in all the possible encoding modes, and a mode having the smallest RD cost is determined as an encoding mode for the current macroblock. Then, the encoding is performed on the current macroblock in the determined encoding mode. In particular, when 4×4 blocks are intra predicted in the scanning order according to the exemplary embodiment of the present invention, some of the blocks can be intra predicted in parallel, thereby reducing the time required for the intra prediction.

Once prediction data to be referred to by a macroblock of a current frame is found through the inter prediction or the intra prediction, it is extracted from a macroblock of a current picture. The remaining of the macroblock is transformed by the transformation unit 108 and is quantized by the quantization unit 110. The remaining of the macroblock after the extraction of the prediction data is called a residual. The residual is also encoded to reduce the amount of data in the encoding. The quantized residual passes through the rearrangement unit 112 to be encoded by the entropy encoding unit 114.

To obtain a reference picture to be used for the inter prediction, a quantized picture passes through the inverse quantization unit 116 and the inverse transformation unit 118 to reconstruct a current picture. The reconstructed current picture is stored in the frame memory 122 and is used later for the inter prediction of a next picture. Once the reconstructed current picture passes through the filter 120, the original picture having additional encoding errors is obtained.

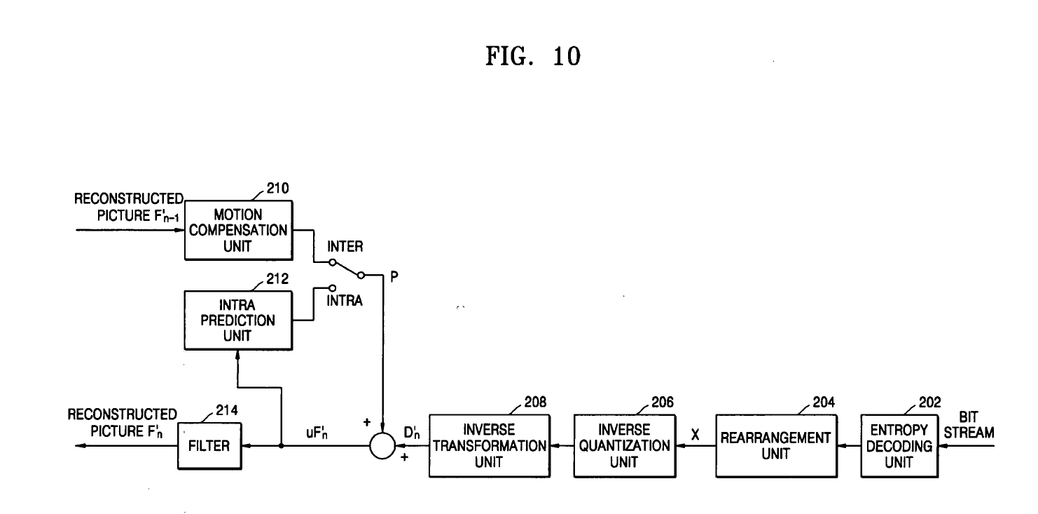

FIG. 10 is a block diagram of a decoder according to the exemplary embodiment of the present invention.

The decoder includes an entropy decoding unit 202, a rearrangement unit 204, an inverse quantization unit 206, an inverse transformation unit 208, a motion compensation unit 210, an intra prediction unit 212, and a filter 214.

The entropy decoder 202 and the rearrangement unit 204 receive a compressed bitstream and perform entropy decoding to generate a quantized coefficient X. The inverse quantization unit 206 and the inverse transformation unit 208 perform inverse quantization and inverse transformation on the quantized coefficient X to extract transformation encoding coefficients, motion vector information, and header information. The motion compensation unit 210 and the intra prediction unit 212 generate a prediction block using decoded header information according to an encoded picture type. An error value D′ₙ is added to the prediction block to generate uF′ₙ. uF′ₙ passes through the filter 214, thereby generating a reconstructed picture F′ₙ. In particular, like in the encoder described above, the intra prediction unit 212 used in the decoder according to the exemplary embodiment of the present invention allows some of the blocks to be intra predicted in parallel, thereby reducing the time required for intra prediction.

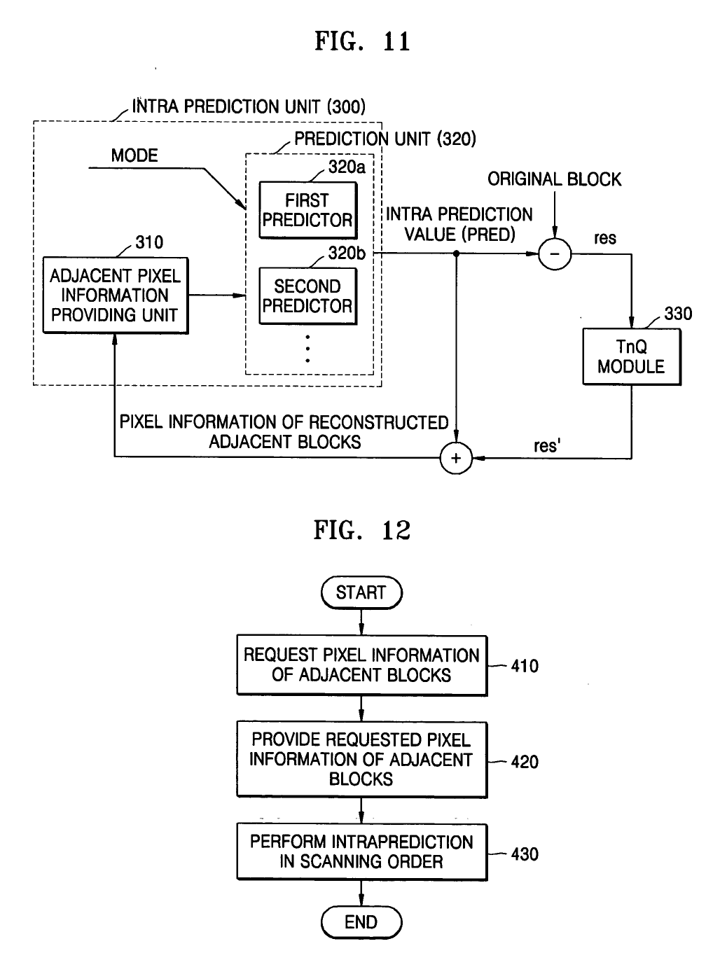

FIG. 11 is a block diagram of an intra prediction unit used in an encoder/decoder according to the exemplary embodiment of the present invention.

An intra prediction unit 300 includes an adjacent pixel information providing unit 310 and a prediction unit 320.

The adjacent pixel information providing unit 310 provides pixel information of adjacent blocks required by the prediction unit 320 that performs the intra prediction.

The prediction unit 320 includes at least two first and second predictors 320a and 320b that perform intra prediction.

The first predictor 320a and the second predictor 320b perform intra prediction on 4×4 blocks. In particular, the first predictor 320a and the second predictor 320b may operate in parallel in the scanning order according to the exemplary embodiment of the present invention except for the processing of some of the blocks. In other words, except for when 1^{st}, 2^{nd}, 8^{th}, 14^{th}, and 15^{th} blocks are intra predicted, the first predictor 320a and the second predictor 320b can perform parallel intra predictions.

A difference ‘res’ between an intra prediction value PRED output from the prediction unit 320 and the original block is output to a TnQ module 330.

The TnQ module 330 performs transformation, quantization, and inverse transformation on the difference ‘res’ to output a difference res' having a quantization error. The difference res' is added to the intra prediction value PRED to generate pixel information of reconstructed adjacent blocks. The pixel information of the reconstructed adjacent blocks is provided to the adjacent pixel information providing unit 310.

When the prediction unit 320 requests pixel information of adjacent blocks required for the intra prediction, the adjacent pixel information providing unit 310 provides the pixel information of the reconstructed adjacent blocks.

As described above, when the intra prediction is performed in the scanning order according to the exemplary embodiment of the present invention, blocks that do not require pixel information of reconstructed adjacent blocks can be intra predicted in parallel, thereby reducing the time required for the intra prediction.

FIG. 12 is a flowchart illustrating an intra prediction method according to the exemplary embodiment of the present invention.

The prediction unit 320 initiates intra prediction on a 0^{th} 4×4 block in the scanning order according to the exemplary embodiment of the present invention. The prediction unit 320 requests pixel information of adjacent blocks required for intra prediction from the adjacent pixel information providing unit 310 in operation 410. Here, if the prediction unit 320 includes a plurality of predictors, it can perform parallel intra predictions. Thus, the prediction unit 320 may request pixel information of a plurality of adjacent blocks from the adjacent pixel information providing unit 310 in the scanning order according to the number of predictors included in the prediction unit 320.

The adjacent pixel information providing unit 310 accepts a request from the prediction unit 320 and provides the requested pixel information of adjacent blocks to the prediction unit 320 in operation 420. When the prediction unit 320 requests pixel information of a plurality of adjacent blocks, if the processing of the adjacent blocks is completed, the adjacent pixel information providing unit 310 provides the requested pixel information of the adjacent blocks to enable the prediction unit 320 to perform parallel intra predictions. However, if the processing of the adjacent blocks is not completed, the adjacent pixel information providing unit 310 informs the prediction unit 320 of the processing of the adjacent blocks being in progress, thereby allowing the intra prediction only using pixel information of currently available adjacent blocks.

The prediction unit 320 performs intra prediction in the scanning order according to the exemplary embodiment of the present invention using the provided pixel information of adjacent blocks in operation 430.

The present invention can also be applied to video compression standards using intra prediction, such as MPEG-1, MPEG-2, MPEG-4 Visual, H.261, and H.263, in addition to H.264/AVC.

According to the exemplary embodiment of the present invention, intra prediction is performed in the scanning order of blocks of a macroblock, i.e., the processing order of blocks, which is different from a conventional scanning order, without additional hardware resources, thereby improving the processing speed in a specific intra mode by about 40%.

In addition, according to the exemplary embodiment of the present invention, the time required for intra prediction can be reduced. In particular, clock cycles required for intra prediction of 4×4 blocks that require the most amount of time among blocks of various forms, are reduced by approximately 40%. The exemplary embodiment of the present invention can also be applied to intra prediction or inter prediction of 8×8 blocks or 16×16 blocks.

Meanwhile, the present invention can also be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over network of coupled computer systems so that the computer-readable code is stored and executed in a decentralized fashion.

While the exemplary embodiment of the present invention has been particularly shown and described with reference to the accompanying drawings, it will be understood by those of ordinary skill in the art that various changes in form and details may be made therein without departing from the spirit and scope of the present invention as defined by the following claims. It will be understood that the particular method and the structure embodying the invention is shown by way of illustration only and not as a limitation of the invention. The principles and features of this invention may be employed in varied and numerous embodiments without departing from the scope of the invention.

What is claimed is:

1. An intra prediction method of intra predicting a macroblock divided into a plurality of blocks, the intra prediction method comprising:
intra predicting the plurality of blocks in a predetermined scanning order,
wherein at least one block among the plurality of blocks is intra predicted independently of an immediately preceding block of the at least one block that is intra predicted immediately before the at least one block and is intra predicted in parallel with the immediately preceding block.

2. The intra prediction method of claim 1, wherein the predetermined scanning order maximizes the number of blocks that are intra predicted in parallel with respective immediately preceding blocks.

3. The intra prediction method of claim 1, wherein the at least one block is intra predicted using pixel information of previous blocks that are intra predicted at least two blocks earlier than the at least one block in the predetermined scanning order.

4. The intra prediction method of claim 1, wherein the macroblock is divided into 16 blocks and intra prediction of the 16 blocks is performed in a scanning order expressed by a matrix
$$[ \begin{matrix}0 & 1 & 3 & 5 \\ 2 & 4 & 7 & 9 \\ 6 & 8 & 11 & 13 \\ 10 & 12 & 14 & 15\end{matrix} ] .$$

5. The intra prediction method of claim 4, wherein blocks other than 1^{st}, 2^{nd}, 8^{th}, 14^{th}, and 15^{th} blocks indicated in the matrix are intra predicted in parallel with respective immediately preceding blocks.

6. The intra prediction method of claim 4, wherein intra prediction of the 1^{st}, 2^{nd}, 8^{th}, 14^{th}, and 15^{th} blocks indicated in the matrix is initiated after intra prediction and reconstruction of respective immediately preceding blocks is completed.

7. The intra prediction method of claim 6, wherein the reconstruction comprises transformation, quantization, and inverse transformation with respect to the respective immediately preceding blocks.

8. An intra prediction method of intra predicting a macroblock in units of a predetermined block, the intra prediction method comprising:
requesting pixel information of adjacent blocks required for intra prediction of the predetermined block in a predetermined scanning order;
receiving the requested pixel information of adjacent blocks; and
performing intra prediction in the predetermined scanning order,
wherein the predetermined scanning order enables at least one block to be intra predicted in parallel with an immediately preceding block of the least one block.

9. The intra prediction method of claim 8, wherein the predetermined block is a 4×4 block and intra prediction of the predetermined block is performed in the predetermined scanning order expressed by a matrix
$$[ \begin{matrix}0 & 1 & 3 & 5 \\ 2 & 4 & 7 & 9 \\ 6 & 8 & 11 & 13 \\ 10 & 12 & 14 & 15\end{matrix} ] .$$

10. The intra prediction method of claim 9, wherein intra prediction of blocks other than 1^{st}, 2^{nd}, 8^{th}, 14^{th}, and 15^{th} blocks indicated in the matrix, is initiated in parallel with intra prediction of respective, immediately preceding blocks by requesting pixel information of adjacent blocks required for intra prediction of the blocks before intra prediction and reconstruction of the respective, immediately preceding blocks are completed.

11. The intra prediction method of claim 10, wherein the reconstruction comprises transformation, quantization, and inverse transformation with respect to the respective, immediately preceding blocks.

12. An intra prediction apparatus for intra predicting a macroblock divided into a plurality of blocks, the intra prediction apparatus comprising:
an adjacent pixel information providing unit providing pixel information of adjacent blocks used in intra prediction; and
a prediction unit requesting the pixel information of adjacent blocks from the adjacent pixel information providing unit and performing intra prediction using the received pixel information of adjacent blocks,
wherein the prediction unit performs the intra prediction in a predetermined scanning order that enables at least one block to be intra predicted in parallel with an immediately preceding block of the at least one block.

13. The intra prediction apparatus of claim 12, wherein the blocks are 4×4 blocks and are intra predicted in a processing order expressed by a matrix
$$[ \begin{matrix}0 & 1 & 3 & 5 \\ 2 & 4 & 7 & 9 \\ 6 & 8 & 11 & 13 \\ 10 & 12 & 14 & 15\end{matrix} ] .$$

14. The intra prediction apparatus of claim 13, wherein the prediction unit intra predicts blocks, except for 1^{st}, 2^{nd}, 8^{th}, 14^{th}, and 15^{th} blocks indicated in the matrix, in parallel with respective immediately preceding blocks.

15. The intra prediction apparatus of claim 13, wherein the prediction unit initiates intra prediction of the 1^{st}, 2^{nd}, 8^{th}, 14^{th}, and 15^{th} blocks respectively after intra prediction and reconstruction of respective, immediately preceding blocks are completed respectively.

16. The intra prediction apparatus of claim 15, wherein the reconstruction comprises transformation, quantization, and inverse transformation with respect to the respective, immediately preceding blocks.

17. The intra prediction apparatus of claim 15, wherein an immediately preceding block comprises one of 0^{th}, 1^{st}, 7^{th}, 13^{th}, and 14^{th} blocks indicated in the matrix.

18. A program product embodied on a computer-readable medium storing a program including program instructions executed by a computer for executing an intra prediction method of intra predicting a macroblock in units of a predetermined block, the intra prediction method comprising:
requesting pixel information of adjacent blocks required for intra prediction of the predetermined block in a predetermined scanning order;
receiving the requested pixel information of adjacent blocks; and
performing intra prediction in the predetermined scanning order,
wherein the predetermined scanning order enables at least one block to be intra predicted in parallel with an immediately preceding block of the least one block.
